(19) United States
(12) Patent Application Publication
(10) Pub. No.: US 2008/0012464 A1
(43) Pub. Date: Jan. 17, 2008

(54) IMAGE DISPLAY DEVICE AND METHOD FOR MANUFACTURING THE SAME

(76) Inventors: Hiroyuki Tachihara, Ooamishirasato (JP); Akira Hatori, Chiba (JP); Kouichi Shouji, Chosei (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/775,970

(22) Filed: Jul. 11, 2007

(30) Foreign Application Priority Data
Jul. 11, 2006 (JP) 2006-190231

(51) Int. Cl. H01J 1/62; H01J 9/02

(52) U.S. Cl. 313/483; 445/24

(57) ABSTRACT

In a display in which two substrates are disposed facing each other with the inner pressure reduced, spacers are used to keep the distance between the two substrates. The spacers are fixed to the substrates using a fixing material obtained by hardening a paste-like adhesive. By transferring paste to each of the spacers, drying the paste applied to the spacer, and applying paste to the dried paste, the amount of paste to be attached to the spacer can be controlled.

### BACKGROUND OF THE INVENTION

1. Field of the Invention

The present invention relates to an image display device, particularly, an image display device based on an MIM FED in which paste is used to fix spacers and a method for manufacturing the same.

2. Description of the Related Art

An MIM FED is a so-called flat vacuum display tube formed of two glass plates and a glass frame, and spacers are disposed inside to prevent implosion.

The ends of the spacers that come into contact with the two glass plates are fixed thereto using hardened paste.

Examples of a method for applying paste onto a glass substrate or a spacer include dispensing, printing and transferring. Transferring is a method for applying paste onto a spacer including the steps of dipping an end of the spacer to which paste is desirably applied in the paste spread to a certain film thickness in advance and pulling the end of the spacer out of the paste. Transferring has an advantage in terms of manufacturing cost compared to the other methods.

JP-A-2000-251800 describes an image display in which the surface adhesion energy at the portions of a spacer with which front and rear plates come into contact is enhanced to transfer and apply an adhesive to the contact portions.

In conventional transferring, it is difficult to substantially increase the amount of paste and ensure a sufficient amount of paste to temporarily fix a spacer.

### SUMMARY OF THE INVENTION

In an image display device including a first substrate on which electron sources are formed, a second substrate on which fluorescent surfaces corresponding to the electron sources are formed, a frame that is disposed between the first and second substrates and surrounds the electron sources and the fluorescent surfaces, and spacers that keep the distance between the first and second substrates facing each other, electrons emitted from the electron sources causing fluorophores on the fluorescent surfaces to emit light so as to display images, the spacers are fixed to the first or second substrate using a fixing material having a multi-stepped structure.

In a method for manufacturing an image display device including a first substrate on which electron sources are formed, a second substrate on which fluorescent surfaces corresponding to the electron sources are formed, a frame that is disposed between the first and second substrates and surrounds the electron sources and the fluorescent surfaces, and spacers that keep the distance between the first and second substrates facing each other, electrons emitted from the electron sources causing fluorophores on the fluorescent surfaces to emit light so as to display images, the method includes the steps of transferring and applying paste onto the spacers, drying the paste, transferring and applying paste onto the spacers again, and hardening the paste, and the spacers are fixed to the first or second substrate using the hardened paste having a multi-stepped structure.

In the transferring step, the state of the interface determines the amount of paste to be attached. Therefore, by drying or half-drying the paste attached in the first transferring step, more paste can be attached in the next transferring step.

First, the same transferring operation as that conventionally performed is carried out once. After the transferring step, the paste attached to the spacer is dried. After the drying step, the same transferring operation as that conventionally performed is carried out again to increase the amount of attached paste.

According to the invention, in the step of using transferring to apply paste, the amount of applied paste can easily be increased.

In a conventional method in which spacers are temporarily fixed in one transferring operation, insufficient spacer holding strength causes difficulty in product assembling. According to the invention, however, a sufficient amount of paste obtained by multiple transferring operations can temporarily fix the spacers in a secure manner. Furthermore, the paste application and the spacer assembly can be simultaneously carried out.

### BRIEF DESCRIPTION OF THE DRAWINGS

FIG. 1 is a cross-sectional view of an image display according to the invention;

FIG. 2 is a process diagram of the method for manufacturing an image display according to the invention; and

FIG. 3A and FIG. 3B show the shape of the paste according to the invention and that of a comparative example.

### DESCRIPTION OF THE PREFERRED EMBODIMENTS

Embodiments of the invention will be described below with reference to the drawings.

### First Embodiment

The invention relates to a display device in which two substrates are disposed facing each other with the inner pressure reduced. Spacers are used to keep the distance between the two substrates. The spacers are fixed to the substrates using a fixing material obtained by hardening a paste-like adhesive.

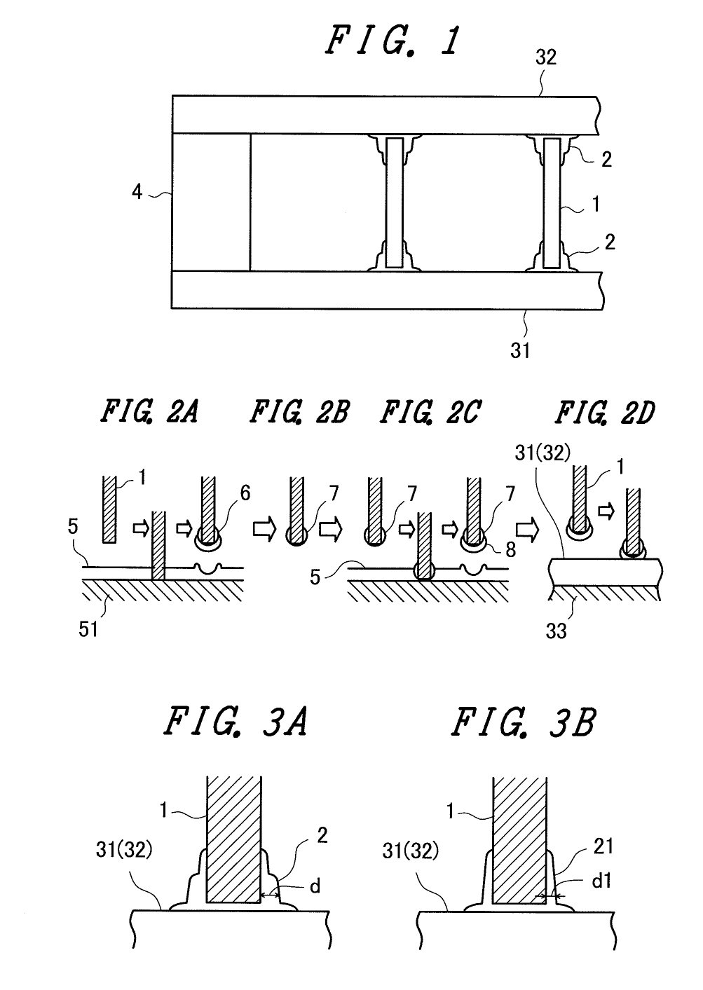

FIG. 1 is a cross-sectional view of the image display according to the invention.

The image display includes a first substrate on which electron sources are formed (electron source-side substrate) and a second substrate on which fluorescent surfaces corresponding to the electron sources are formed (phosphor-side substrate). A frame is disposed between the first and second substrates. The frame is disposed in such a way that it surrounds the electron sources on the first substrate and the fluorescent surfaces on the second substrate. That is, the frame is disposed on the opposing surfaces of the substrates along the peripherals thereof. Spacers are disposed between the first and second substrates in order to keep the distance between the opposing substrates.

Electrons emitted from the electron sources can cause fluorophores on the fluorescent surfaces to emit light so as to display images.

The exterior of the fixing material that fixes each spacer has a stepped structure. In such a configuration, each spacer can be securely fixed.

The present embodiment will be described with reference to the case where an MIM FED is used as the image display. The MIM FED includes an electron source-side substrate 31 on which MIM electron sources are formed in a matrix, a phosphor-side substrate 32 on which fluorescent surfaces corresponding to the MIM electron sources are formed, the substrates 31 and 32 disposed facing each other, and a supporting frame 4 that seals the peripherals of the substrates 31 and 32 to form a vacuum therebetween. Electrons emitted from the MIM electron sources cause fluorophores to emit light so as to display images. The electron source-side substrate 31 and the phosphor-side substrate 32 are preferably made of glass.

In FIG. 1, the spacers 1 keep the distance between the electron source-side substrate 31 and the phosphor-side substrate 32 that face each other. At least one of the upper and lower ends of each of the spacers 1 is fixed to the electron source-side substrate 31 or the phosphor-side substrate 32 using hardened paste 2. The hardened paste 2 is a fixing material having a multi-stepped structure obtained by a plurality of transfer and application processes.

### Second Embodiment

The image display according to the present embodiment includes a first substrate on which electron sources are formed (electron source-side substrate) and a second substrate on which fluorescent surfaces corresponding to the electron sources are formed (phosphor-side substrate). A frame is disposed between the first and second substrates. The frame is disposed in such a way that it surrounds the electron sources on the first substrate and the fluorescent surfaces on the second substrate. That is, the frame is disposed on the opposing surfaces of the substrates along the peripherals thereof. Spacers are disposed between the first and second substrates in order to keep the distance between the opposing substrates.

Electrons emitted from the electron sources can cause fluorophores on the fluorescent surfaces to emit light so as to display images.

The spacers are fixed to one or both of the first and second substrates using a fixing material.

The manufacturing method according to the present embodiment includes the step of fixing the spacers to the substrates. Specifically, the step of fixing the spacers includes the steps of transferring and applying paste onto each of the spacers, drying the paste, transferring and applying paste on the dried paste, and hardening the paste.

The spacers are fixed to the first or second substrate using the hardened paste having a multi-stepped structure.

FIG. 2 is a process diagram of the method for manufacturing an image display according to the invention.

In the present embodiment, in the step (a), paste 5 is first applied onto an application workbench 51 in such a way that the paste 5 has a uniform film thickness. The spacer 1 is dipped in the paste 5 having a uniform film thickness to transfer (or apply) first paste 6 to the spacer 1.

Then, in the step (b), the transferred and applied first paste 6 is dried to form dried paste 7.

In the next step (c), the spacer 1 to which the dried paste 7 is attached is dipped in the paste 5 again to transfer (or apply) second paste 8 around the dried paste 7.

Then, in the step (d), the spacer 1 to which the paste 7 and 8 are attached is temporarily fixed to the electron source-side substrate 31 or the phosphor-side substrate 32 on a mounting workbench 33. The paste 7 and 8 are then hardened.

In FIG. 2, although the description has been made with reference to one spacer, in practice, a plurality of spacers 1 are held at predetermined intervals using an apparatus or a fixture, and the plurality of spacers 1 are together temporarily fixed to the electron source-side substrate 31 (or the phosphor-side substrate 32). Then, the plurality of spacers 1 temporarily fixed to the electron source-side substrate 31 (or the phosphor-side substrate 32) are temporarily fixed to the phosphor-side substrate 32 (or the electron source-side substrate 31). Then, the paste is hardened. The hardened paste becomes a fixing material (or adhesive) 2 that fixes the spacers 1 to the electron source-side substrate 31 (or the phosphor-side substrate 32).

FIG. 3A and FIG. 3B show the shape of the paste according to the invention and that of a comparative example. FIG. 3A shows how the spacer 1 adheres to the electron source-side substrate 31 (or the phosphor-side substrate 32) when the process of transferring and applying the paste onto the spacer 1 according to the invention has been carried out twice, while FIG. 3B shows how the spacer 1 adheres to the electron source-side substrate 31 (or the phosphor-side substrate 32) when the process of transferring and applying the paste has been carried out once.

In FIG. 3A and FIG. 3B, the thickness d of the fixing material 2 according to the invention in the width direction is approximately doubled compared to the thickness dl of a fixing material 21 in the comparative example, resulting in an increased strength at which the spacer 1 is fixed to the electron source-side substrate 31 or the phosphor-side substrate 32. By changing the thickness of the paste 5 formed on the application workbench 51 shown in FIG. 2, the size of the step of the fixing material 2 shown in FIG. 3A can be reduced, and the distance between the steps can be changed.

In the present embodiment, the number of transferring and applying processes is not limited to two, but can be a larger number as required so as to provide a paste width having necessary strength. Furthermore, multiple kinds of pastes can be used to form a multilayer structure.

What is claimed is:

1. An image display device comprising:
a first substrate on which electron sources are formed;
a second substrate on which fluorescent surfaces corresponding to the electron sources are formed;
a frame that is disposed between the first and second substrates and surrounds the electron sources and the fluorescent surfaces, and;
spacers that keep the distance between the first and second substrates facing each other, electrons emitted from the electron sources causing fluorophores on the fluorescent surfaces to emit light so as to display images,
wherein the spacers are fixed to the first or second substrate using a fixing material having a multi-stepped structure.

2. A method for manufacturing an image display device including a first substrate on which electron sources are formed, a second substrate on which fluorescent surfaces corresponding to the electron sources are formed, a frame that is disposed between the first and second substrates and surrounds the electron sources and the fluorescent surfaces, and spacers that keep the distance between the first and second substrates facing each other, electrons emitted from the electron sources causing fluorophores on the fluorescent surfaces to emit light so as to display images, the method comprising the steps of:
transferring and applying paste onto the spacers;
drying the paste;
transferring and applying paste onto the spacers again; and
hardening the paste,
wherein the spacers are fixed to the first or second substrate using the hardened paste having a multi-stepped structure.
